(19) United States
(12) Patent Application Publication
(10) Pub. No.: US 2013/0030921 A1
(43) Pub. Date: Jan. 31, 2013

(54) Serving advertisements based on user data

(71) Applicant: John C. BRANDENBURG, Phoenix, MD (US)

(72) Inventor: John C. BRANDENBURG, Phoenix, MD (US)

(73) Assignee: Millennial Media

(21) Appl. No.: 13/137,178

(22) Filed: Jul. 26, 2011

(51) Int. Cl. G06Q 30/00

(52) U.S. Cl. 705/14.66

(57) ABSTRACT

A method, system, and computer-readable storage device for serving advertisements based on user data using a computer network are provided. In at least one embodiment, a method may comprise receiving a request from a publisher for at least one advertisement, wherein the request comprises user context data. The method may also comprise receiving a permission profile from the publisher corresponding to the user context data, wherein the permission profile defines permissive use of the user context data. The method may also comprise supplementing previously stored data with the user context data and determining at least one advertisement based on the supplemented data and the permission profile.

### TECHNICAL FIELD

The techniques as described herein generally relate to serving advertisements based on user data using a computer network.

### BACKGROUND

Online advertising has been a growing industry since the mid-1990's. In recent years, however, the field of mobile advertising—especially display mobile advertising—has blossomed. This is because, in today's technological environment, mobile devices (e.g., phones, smartphones, tablets, etc.) contain faster and more powerful processors and thus can be utilized for much more than just making and receiving voice telephone calls. That is, besides voice services, mobile telephone users have access to data services such Short Message Service (SMS or better known as “text messaging”), picture messaging, content downloads and access to the Mobile Web. These media channels have the capability to carry both content and advertising. Consequently, mobile advertising is a rapidly growing sector providing brands, agencies and marketers the opportunity to connect with consumers directly on their mobile telephones, while bypassing traditional and other digital media.

Those skilled in the relevant art(s) will recognize that mobile telephones are extremely personal devices as one mobile telephone typically has only one unique user. This makes the mobile telephone a precisely targeted communication channel, where users are highly engaged with the content available thereon. Fittingly, the mobile channel delivers excellent campaign effectiveness and response levels compared to other advertising media. Mobile advertising provides advertisers the ability to promote and inform consumers of their products and services. It also enables publishers and content providers to monetize their valuable assets.

Mobile advertising can be in the form of text, links, images, videos or any combination of these elements. More specifically, when designing a mobile advertising campaign, there are multiple channels available to reach the consumer (i.e., mobile device user). These channels include Mobile Web sites, mobile applications, mobile messaging and mobile video, all of which can be integrated into the interactive campaigns. Each channel can link to additional mobile content or channels (as well as, in some instances, complementing traditional media). Mobile provides a powerful instant and interactive response path, such as consumers sending a keyword to a short code via SMS, or registering on a Mobile Web site.

The multiple possible elements of mobile advertising provide an interactive experience for potential customers. For an advertiser to really engage a potential customer, however, the advertisement must also be relevant to the user who views it. For example, people without children are unlikely to be interested in advertisements for diapers. Similarly, advertisements for rain gear are unlikely to find a receptive audience with those users who live in areas with little rainfall. Thus, to provide relevant advertisements, advertisers typically require some information about the user such that the user's interests are uniquely identified. In addition, other context, device and network parameters can help fine tune the analysis that presents the most appropriate advertisement for both the user and the advertiser.

The mobile advertising infrastructure at the most basic level consists of a publisher network which is directly or indirectly connected to the advertisement network which responds to the request of a relevant advertisement from the publisher network. Another embodiment could be implemented using an advertisement (ad) exchange server that can work with both the publisher network directly as well as the publisher's advertisement network server. The advertisement exchange server can act as a hub to multiple such publisher advertisement network servers wherein the exchange server helps facilitate and manage the advertisement request from the publisher. The advertisement exchange server is connected to the advertisement server which is tasked with picking the appropriate advertisement for the publisher advertisement request.

The context, device and network related information is generally sent to a publisher server within the mobile network in the form of header information embedded in the communication from the mobile device to the publisher server. This, in turn, is passed on to an advertising server or the media network for use in advertisement analysis and decision-making.

In addition to the network and device related parameters, the publisher might have more information about the context such as more information about the user profile such as gender, location, age demographics, interests, past history, etc. Such information can be passed on by the publisher to the advertisement exchange server directly or via the participating advertisement network.

Unlike the online infrastructure, not all mobile devices have the facility to help identify the machine (computers, laptops, desktops, etc.) and the user of the machine.

The lack of understanding about the user has the potential of presenting the user with the advertisement that is not relevant in the given context. This is not good for the user, the advertiser, or the publisher.

### SUMMARY

A method, system, and computer-readable storage device for serving advertisements based on user data using a computer network are provided. In at least one embodiment, a method may comprise receiving a request from a publisher for at least one advertisement, wherein the request comprises user context data. The method may also comprise receiving a permission profile from the publisher corresponding to the user context data, wherein the permission profile defines permissive use of the user context data. The method may also comprise supplementing previously stored data with the user context data and determining at least one advertisement based on the supplemented data and the permission profile.

In another embodiment, a system for serving advertisements may comprise a processor and a memory coupled to the processor. The memory may store instructions to direct the processor to perform operations, the operations comprising receiving a request from a publisher for at least one advertisement, wherein the request comprises user context data. The operations may also comprise receiving a permission profile corresponding to the user context data, wherein the permission profile defines permissive use of the user context data. The operations may also comprise supplementing previously stored data with the user context data and determining at least one advertisement based on the supplemented data and the permission profile.

In yet another embodiment, a computer-readable storage device may store instructions for serving advertisements, the instructions causing one or more computer processors to perform operations. The operations comprising receiving a request from a publisher for at least one advertisement, wherein the request comprises user context data. The operations may also comprise receiving a permission profile corresponding to the user context data, wherein the permission profile defines permissive use of the user context data. The operations may also comprise supplementing previously stored data with the user context data and determining at least one advertisement based on the supplemented data and the permission profile.

### BRIEF DESCRIPTION OF THE DRAWINGS

The accompanying drawings, which are incorporated in and constitute a part of this specification, illustrate various embodiments of the techniques, as described herein, and together with the description, serve to explain the principles of the techniques. In the drawings:

FIG. 1 is a high-level block diagram of an exemplary advertising system in which an embodiment of the techniques may be implemented;

FIG. 2 is a more-detailed block diagram of an exemplary advertising system in which an embodiment of the techniques may be implemented;

FIG. 3 is a flowchart of an exemplary decision engine process for advertising exchange in accordance with some embodiments of the techniques;

FIG. 4 are flow diagrams of exemplary advertising exchange processes in accordance with some embodiments of the techniques; and

FIG. 5 is a block diagram of an exemplary computer system useful for implementing an embodiment of the techniques.

### DETAILED DESCRIPTION

Described below are techniques for serving advertisements based on user data using a computer network. Aspects of the techniques may be used for, for example, mobile devices such as mobile telephones, which can include both feature phones, and also high-end devices such as PDAs, smart phones (e.g., an iPhone® handset), and tablets (e.g., an iPad®). In addition, mobile devices can be other electronic devices such as, but not limited to, tablets, eReaders, tracking devices, automobiles, kiosks, netbooks, notebooks, refrigerator displays, and other devices which use wireless as a means for connectivity to the global, public Internet or other related servers.

Advertising as a means to inform users about various products and services has been around for centuries. With recent advances in technology, the process of delivering relevant advertising directly to consumers, through a variety of devices, has improved significantly. The online (primarily desktop) advertising market has been maturing over the last fifteen years. With the proliferation of mobile devices around the globe, mobile advertising has also blossomed over the past few years. The main players in the ecosystem are the device manufacturers who build the devices and associated software (e.g., Nokia, Apple and Motorola); the operators who manage the mobile networks (e.g., AT&T Wireless, Sprint and Verizon Wireless) (wireless connectivity can also be provided by hotspots and other means in which case the facility provider or the access providers will act as an operator); the publisher or the content provider who is engaging the user with its content (e.g., CNN, ABC and WSJ); and the mobile advertisement network operators (e.g., Google).

Advertising requests may originate from different sources including, but not limited to, a web browser, an application, an embedded application such as an idle screen application that comes with a device, or a Web service or a framework that can combine any of the foregoing. Such requests may be generated as a result of a user-generated activity (e.g., user goes to a specific website which requests an advertisement, user launches an application which requests an advertisement either at launch or shutdown, or during the course of the application use). In some cases, a user may not be actively engaged with the device but an agent pulls the information on the user's behalf. For example, digital displays on refrigerators or elevators can pull information without user intervention. Similar techniques can be applied to mobile telephones, computer tablets, and other mobile devices.

In order to provide a relevant advertisement that the user is likely to pay attention to, publishers are interested in matching user interests and profiles with appropriate advertisements. Similarly, advertisers are interested in targeting users based on certain parameters such as demographics, location, operator network, device type and the like. For example, a consumer product company may be interested in only targeting males between the ages of 18-35 on AT&T's network who carry the iPhone® handset. In order to match the advertisement to the right user, the advertisement server's decision engine may require the unique user parameters that help determine the user's demographics or age group, while the network ID helps determine the operator network, and the device ID helps determine the device type.

In some embodiments of the techniques described herein, once this information is available, it may be passed on to the publisher. The publisher in turn may pass the information to an advertisement exchange server either directly or through the participating advertisement network. The participating advertisement network might also play a role of a mediation advertising network working in concert with the advertising exchange. This information may be used by the advertisement exchange server to uniquely identify the user so that the advertisement server can select the most relevant advertisement for the user. The uniquely identified information which may be passed on to the exchange by the publisher may be stored, for example, with the exchange server on behalf of the publisher.

In other embodiments, for example, the user information might be pulled from the exchange directly through client-side processing wherein client-side software can logically decide to use the pertinent user information for the advertising request as well as formulate the advertisement request to the advertising exchange and media network. The client-side processing could include but is not limited to the processing within the browser, application, multimedia element, or a combination of the above.

In other embodiments, a set of advertisements might be cached with the publisher and/or the device and the client-side processing may help deliver the most relevant advertisement without making a full request to the advertisement exchange. It might still be necessary to request some user data from the advertisement exchange either directly or through an intermediate server before the most appropriate advertisement is picked and displayed to the end user device.

In some embodiments, the publisher might have some additional information on the user such as, for example, gender or age demographics which can be utilized by the advertisement exchange server in concert with the advertisement server to determine the most appropriate advertisement for the publisher advertisement request. This information may be associated with the unique user ID and saved with the exchange server on behalf of the publisher.

In some embodiments, the exchange might already have some information on the user either from, for example, previous requests from the same publisher or from requests from other publishers or advertisement networks. In such cases, the exchange may supplement the information it already has about the user to develop a better view of the user that may help in determining the most relevant advertisement for the publisher advertisement request. Thus, in some embodiments, the data stored for the user may have come from one or more publishers, or other server or network, while an advertisement request is coming from a different publisher. In some instances, the publisher, the participating advertisement network and the advertisement exchange may work together to gather and store the user information.

The exchange in turn may send the user data along with the original advertisement request to one or more media networks which may be, for example, advertising networks that accept requests and send bids back to the mobile advertising exchange for further processing. The mobile advertising exchange may accept the most relevant bid for the advertisement request and pass on the advertisement from the selected media network to the publisher either directly or through the intermediate server.

In some embodiments, the advertising exchange processes the user information and related data, and matches the request with the most appropriate advertisement for that specific advertisement request. This matching process, or “the decision,” can be based on several rules that the mobile advertisement exchange may have programmed into the decision engine. Some of these rules may be based on the campaigns that the advertiser and the publisher are interested in running. Others may be based on the system frequency-capping limit so that any given advertisement is not shown repeatedly to the user even on different publisher content sites in a given duration, as the effectiveness of the advertisement may wear off if the advertisement is shown too often.

In some embodiments, the advertisement exchange server may have a permissions management system that manages the permissions for the user data being collected and supplemented. In some cases, the publisher might only give the rights to use the user data for only the current advertisement request. In this case, the permissions may not allow for the data to be stored. In other cases, the publisher may grant the rights to use the user information for future publisher advertisement requests. In this case, the publisher is essentially allowing the advertisement exchange to build a user profile on the publisher's behalf.

In some embodiments, the permissions management system may be operated by the mobile advertising exchange. However, in other embodiments, the permissions management system might be operated by an independent third party.

In certain embodiments, the publisher might grant rights for the user data being gathered and stored to be used by third parties. It might, for example, impose certain restrictions or certain conditions depending on the business agreements. For instance, the user data may be used to supplement any advertisement request so long as it is not from a direct competitor or from a publisher with questionable content. In other instances, in exchange for the user of the user data, the publisher is given some value of the transaction. As another example, a publisher might give permission to share only select user variables such as gender or age demographics. In another example, the publisher might choose to share certain variables about the user with certain publishers.

Thus, in some cases, the publisher might allow the user information to be shared such that the user information can be used to supplement advertisement requests from other publishers in order to find the most relevant advertisement for the advertisement request. The incentive for the publishers to share their user data is that they also get the benefits from user data collected from other publishers and advertisement networks.

In some embodiments, the mobile advertising exchange and one or more of the advertising networks can be operated by the same entity. Similarly, in yet other embodiments, the intermediate advertising network, the mobile advertising exchange, and one or more of the advertising networks can be operated by the same entity.

In some embodiments of the advertisement exchange server, user information is distributed and is stored in different databases such as publisher databases, advertisement network databases, and the advertisement exchange databases. At the time of an advertisement request, the advertisement exchange server collects the needed information about the user for the specific advertisement request which is combined and passed on to the advertisement server for further processing. The advertisement server then decides on the appropriate advertisement for the publisher advertisement request.

In yet another embodiment of the advertisement exchange server, a media network might provide some supplemental information which can be stored at the mobile advertising exchange.

The techniques as described herein may allow the publisher to store user data at the exchange and benefit from a universal user profile database in multiple ways. The techniques may enhance the quality of advertisement served on the publisher's content sites but also opens up new business and revenue models.

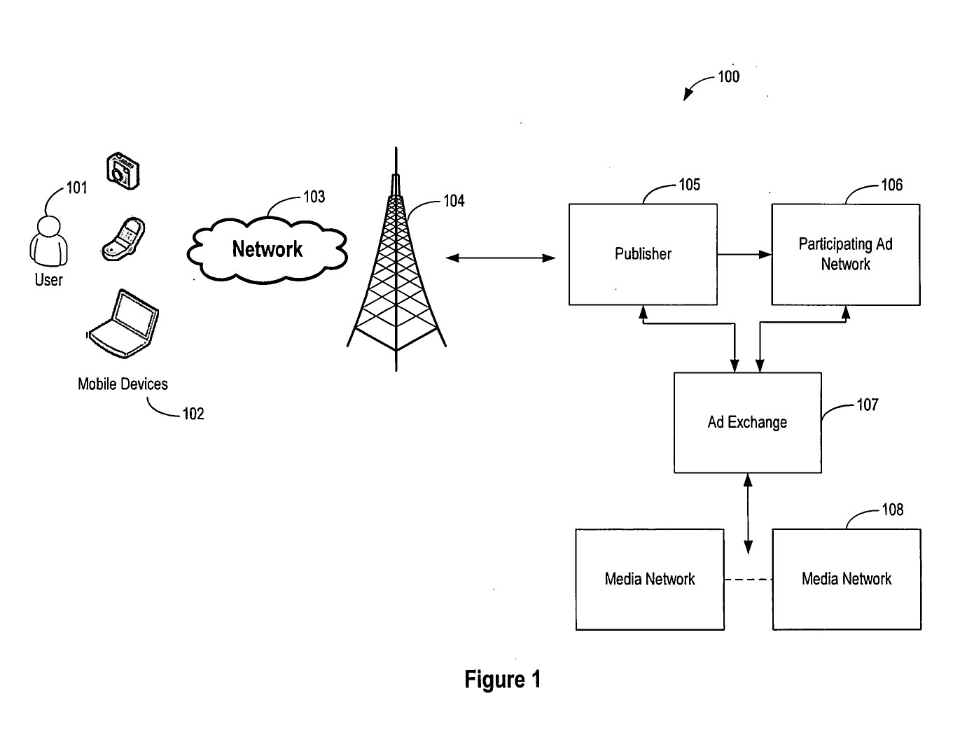

Referring now to FIG. 1, a high-level block diagram of an exemplary advertising system in which an embodiment of the techniques, as described herein, may be implemented, is shown.

As shown, system 100 includes a user 101 who can have multiple mobile devices 102 such as a mobile telephone, a tablet, a netbook, a camera or the like, each of which is connected to a wireless network 103, 104 to access one or more content publisher servers 105. The publisher servers 105, in turn, are connected to one or more participating advertising networks 106. The publisher servers 105 and the participating advertising network 106 are connected to the advertisement exchange server 107 which in turn is connected to the advertisement server 108. The request for an advertisement flows from the publisher server 105 to the advertisement exchange server 107 directly or via the participating advertisement network 106. The advertising exchange server 107 passes on the advertisement request with the appropriate data to the advertisement server 108.

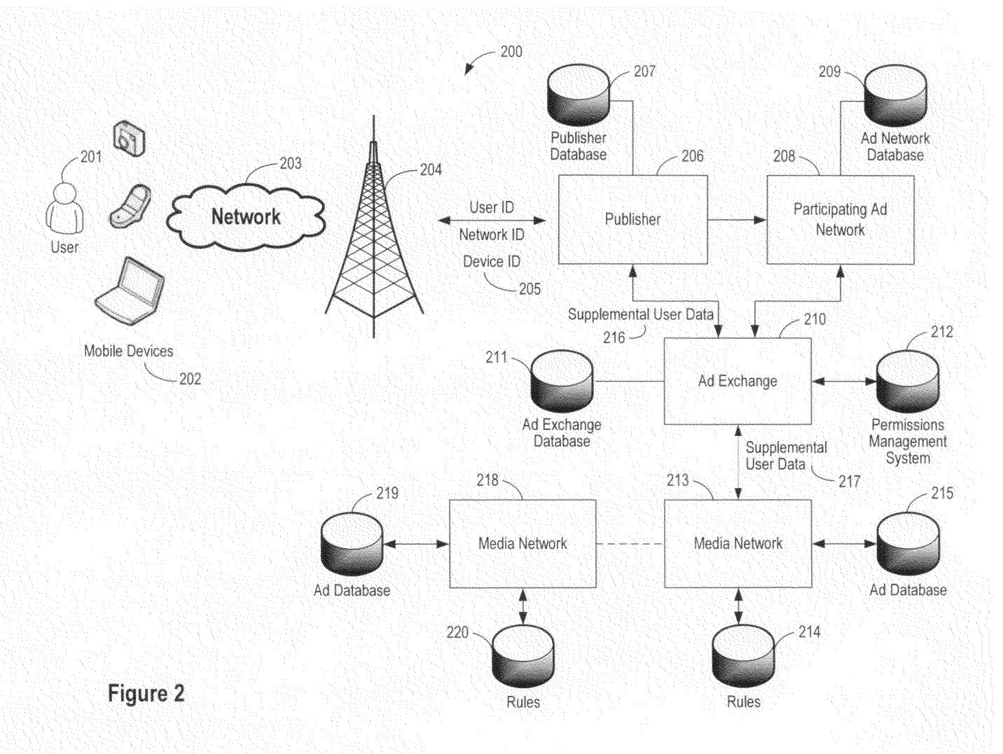

Referring now to FIG. 2, a more-detailed block diagram of an exemplary advertising system in which an embodiment of the techniques, as described herein, may be implemented, is shown.

As shown, system 200 includes a user 201 who can have multiple mobile devices 202 such as, for example, a mobile telephone, a tablet, a notebook, a camera or the like, each of which may be connected to a wireless network 203, 204 to access one or more content publisher servers 206. The network and the devices may pass on the unique identifiers 205, e.g., User ID, Network ID, and Device ID, to the publisher server, which might store this information in the publisher database 207. The publisher database 207 might also store other relevant and unique user profile information such as but not limited to age, gender, income, interests, etc. The publisher server may 206 interact with the advertisement exchange server 210 directly or through a participating advertisement network 208. The participating advertisement network 208 might have its own advertisement network database 209 where it keeps track of the unique user information. This information can be supplemented to the publisher database information that is passed on to the advertisement exchange 210 for further processing

The user profile information from the publisher server 206 or the participating advertisement network server 208 may be sent to the advertisement exchange server 210 which in turn may supplement its own user data stored in the advertisement exchange database 211 and may also store the new information in the database 211. This information may be stored in this database 211 on the behalf of the publisher server 206. The permissions associated with the specific user information may be managed by the permissions management system 212, which grants rights to the advertisement exchange server 210 for further use and processing of the user data. The advertisement exchange server 210 may package the user information and send it to the advertisement server 213 which processes the data and based on the rules 214 picks the most relevant advertisements from the advertisement database 215 in response to the advertisement request from the publisher server 206.

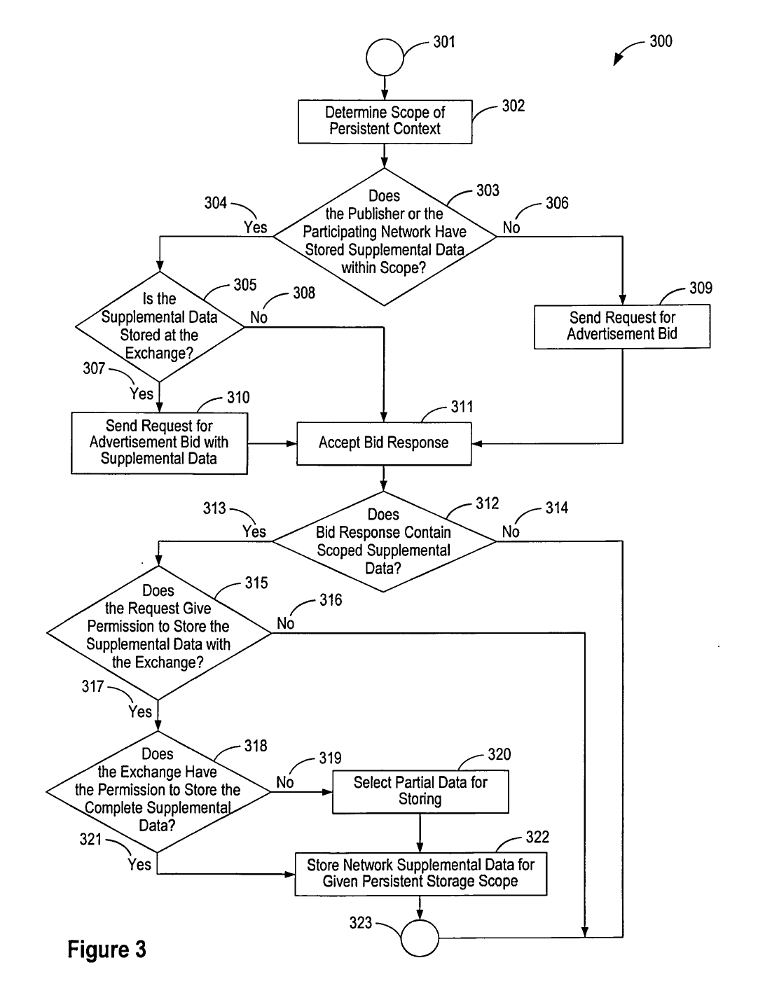

Referring now to FIG. 3, a flowchart of an exemplary decision engine process for advertising exchange in accordance with some embodiments of the techniques, as described herein, is shown.

As shown, the publisher server may request 301 the advertisement from the advertisement exchange server which may try to determine 303 if the publisher or the participating advertising network has the supplemental user data that can be used for determining the most appropriate advertisement for the request. If there is 304 supplemental data for the user and the associated publisher server request, then the advertisement exchange server may determine 305 if such data is stored at the exchange or it needs to 308 use the data from the publisher server or the participating advertising network.

In cases where there is no 306 data available for the user request, the publisher server or the participating advertising network may still send the request for an advertisement 309 to the advertising exchange server. In each of the above cases 307, 308, 309, the advertisement exchange server may determine 310 if it wants to accept the request. If the supplemental data is present 311, 312, the advertising exchange checks on the 314 permissions granted by the publisher server and/or the participating advertising exchange. If the permission is granted 316, the exchange server may check if it has the permission to store the complete information 317 that is being shared 320 or only the partial information 318, 319. Based on the permissions, the exchange stores 321 the relevant supplemental information at the exchange and processes the advertisement request 322.

If the advertisement request doesn't have any supplemental data for the request 311, 313, the exchange may still pass the 322 request for further processing.

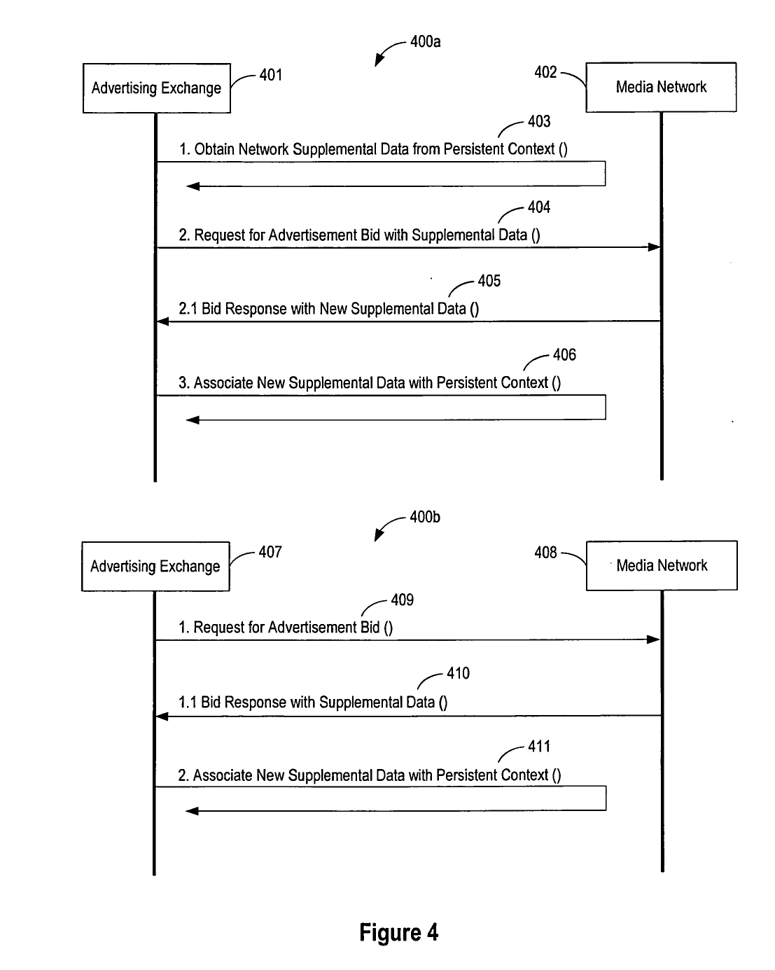

Referring now to FIG. 4, data flow diagrams 400a and 400b, illustrating exemplary advertising exchange processes in accordance with some embodiments of the techniques, as described herein, are shown. In these embodiments, the two main entities in the mobile advertising system are shown: the advertising exchange server 401 and the media network 402 which may include advertising networks that bid on the advertising request based on the supplemental data if available.

Flow 400a represents the advertising exchange-based advertising request with previously stored participating network data.

Flow 400a starts with a request 403 from the advertising exchange 401 to the publisher server or the participating advertising network to obtain the network supplemental data from the context of the advertising request from the advertising exchange server. The mobile advertising exchange server may then make the request 404 to the media network 402 for an advertisement based on the supplemental data and receives a response 405 from the media network 402. For example, if the supplemental data shows a male in the age demographic of 25-34 in New York City, the advertisement could be different for the advertisement request that showed the supplemental data of females in the age demographics of 40-55 in Houston. Upon receiving the response, the advertising exchange 401 may associate 406 the new or the incremental supplemental data with the user.

Flow 400b represents the advertising exchange-based advertising request without stored participating network data.

Flow 400b is similar to flow 400a except that there is no step for obtaining previously stored participating network data since it doesn't exist. The rest of the call flow is similar. The mobile advertising exchange server 407 makes the request 409 to the media network 408 for an advertisement based on the supplemental data and receives a response 410 from the media network 407. Upon receiving the response, the advertising exchange 407 associates 411 the new supplemental data with the user.

In these embodiments, as will be appreciated by those skilled in the relevant art(s) after reading the description herein, the decision process will comply with all the campaign and system rules in the database. Flows 400a and 400b thus help in storing the supplemental user data with the mobile advertising exchange. In cases where some supplemental data is already present, the exchange enhances the data. In cases where no supplemental data exists for the user, the exchange creates a new record for the user and uses the data for future requests depending on the permissions granted.

The techniques described herein (i.e., system 100, system 200, flow 300, flow 400, or any part(s) or function(s) thereof) may be implemented using hardware, software or a combination thereof and may be implemented in one or more computer systems or other processing systems. However, the manipulations performed by the techniques were often referred to in terms, such as adding or comparing, which are commonly associated with mental operations performed by a human operator. No such capability of a human operator is necessary, or desirable in most cases, in any of the operations described herein, which form part of the techniques. Rather, the operations are machine operations. Useful machines for performing the operation of the techniques include general-purpose digital computers or similar devices.

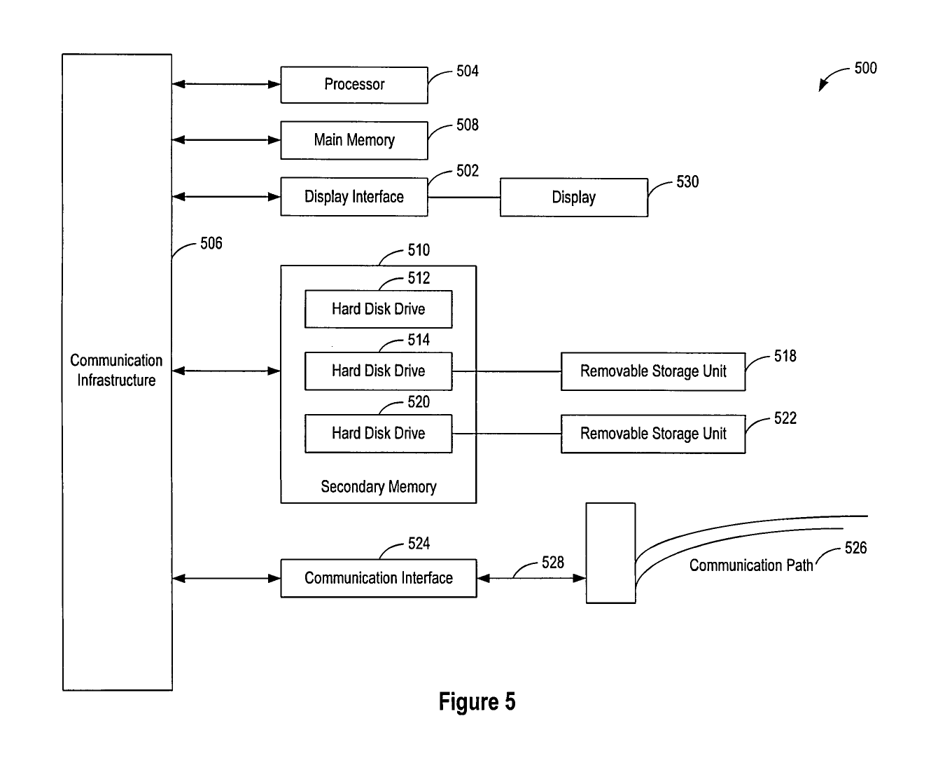

In fact, in one aspect, the techniques are directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software aspects are described in terms of this exemplary computer system. After reading this description, it will become apparent to a person skilled in the relevant art(s) how to implement the techniques using other computer systems and/or architectures.

Computer system 500 can include a display interface 502 that forwards graphics, text and other data from the communication infrastructure 506 (or from a frame buffer not shown) for display on the display unit 530.

Computer system 500 also includes a main memory 508, preferably random access memory (RAM) and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative aspects, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 514, a hard disk installed in hard disk drive 512 and signals 528. These computer program products provide software to computer system 500. The techniques are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the technique, as discussed herein. In particular, the computer programs, when executed, enable the processor 504 to perform the features of the technique. Accordingly, such computer programs represent controllers of the computer system 500.

In an aspect where the techniques are implemented using software, the software may be stored in a computer program product and loaded into computer system 500 using removable storage drive 514, hard drive 512 or communications interface 524. The control logic (software), when executed by the processor 504, causes the processor 504 to perform the functions of the techniques as described herein.

In another aspect, the techniques are implemented primarily in hardware using, for example, hardware components such as application specific integrated circuits (ASICs). Implementation of the hardware state machine so as to perform the functions described herein will be apparent to persons skilled in the relevant art(s).

In yet another aspect, the techniques are implemented using a combination of both hardware and software.

While various aspects of the techniques have been described above, it should be understood that they have been presented by way of example and not limitation. It will be apparent to persons skilled in the relevant art(s) that various changes in form and detail can be made therein without departing from the spirit and scope of the techniques. Thus, the techniques should not be limited by any of the above-described exemplary aspects, but should be defined only in accordance with the following claims and their equivalents.

What is claimed is:

1. A method for serving advertisements, the method comprising:
receiving a request from a publisher for at least one advertisement, wherein the request comprises user context data;
receiving a permission profile from the publisher corresponding to the user context data, wherein the permission profile defines permissive use of the user context data;
supplementing previously stored data with the user context data; and
determining at least one advertisement based on the supplemented data and the permission profile.

2. The method of claim 1, wherein the user context data comprises user profile data.

3. The method of claim 1, wherein the previously stored data is stored by an advertisement server in at least one data repository.

4. The method of claim 3, further comprising:
receiving the supplemented data from the at least one data repository.

5. The method of claim 1, wherein the previously stored data comprises data provided by at least one other publisher.

6. The method of claim 5, wherein at least one other permission profile corresponds to the data provided by the at least one other publisher.

7. The method of claim 1, wherein the permission profile is managed by a permissions management system.

8. The method of claim 1, further comprising:
requesting at least one advertisement bid from at least one media network, wherein the at least one advertisement responsive to the request is determined based on the at least one advertisement bid.

9. The method of claim 8, wherein the at least one advertisement bid also comprises user context data.

10. The method of claim 1, wherein the user context data is received from an intermediate server.

11. A system for serving advertisements, the system comprising:
a processor; and
a memory coupled to the processor, the memory storing instructions to direct the processor to perform operations comprising:
receiving a request from a publisher for at least one advertisement, wherein the request comprises user context data;
receiving a permission profile corresponding to the user context data, wherein the permission profile defines permissive use of the user context data;
supplementing previously stored data with the user context data; and
determining at least one advertisement based on the supplemented data and the permission profile.

12. The system of claim 11, wherein the user context data comprises user profile data.

13. The system of claim 11, wherein the previously stored data is stored by an advertisement server in at least one data repository.

14. The system of claim 11, wherein the previously stored data comprises data provided by at least one other publisher.

15. The system of claim 14, wherein at least one other permission profile corresponds to the data provided by the at least one other publisher.

16. The system of claim 11, wherein the permission profile is managed by a permissions management system.

17. The system of claim 11, wherein the processor is further directed to perform the operation of:
requesting at least one advertisement bid from at least one media network, wherein the at least one advertisement responsive to the request is determined based on the at least one advertisement bid.

18. The system of claim 17, wherein the at least one advertisement bid also comprises user context data.

19. The system of claim 11, wherein the user context data is received from an intermediate server.

20. A computer-readable storage device storing instructions for serving advertisements, the instructions causing one or more computer processors to perform operations, comprising:
receiving a request from a publisher for at least one advertisement, wherein the request comprises user context data;
receiving a permission profile corresponding to the user context data, wherein the permission profile defines permissive use of the user context data;
supplementing previously stored data with the user context data; and
determining at least one advertisement based on the supplemented data and the permission profile.
